(19) United States
(12) Patent Application Publication
(10) Pub. No.: US 2015/0356162 A1
(43) Pub. Date: Dec. 10, 2015

(54) METHOD AND SYSTEM FOR IMPLEMENTING ANALYTIC FUNCTION BASED ON MAPREDUCE

(71) Applicant: Tencent Technology (Shenzhen) Company Limited, Shenzhen (CN)

(72) Inventors: Shubin ZHANG, Shenzhen (CN); Wanpeng TIAN, Shenzhen (CN); Pin XIAO, Shenzhen (CN); Chunjian BAO, Shenzhen (CN); Wei GUO, Shenzhen (CN)

(21) Appl. No.: 14/750,887

(22) Filed: Jun. 25, 2015

Related U.S. Application Data
(63) Continuation of application No. PCT/CN2013/084860, filed on Oct. 9, 2013.

(30) Foreign Application Priority Data
Dec. 27, 2012 (CN) 201210580817.1

(51) Int. Cl. G06F 17/30; G06F 7/24

(52) U.S. Cl. CPC G06F 17/30592; G06F 7/24; G06F 17/30412; G06F 17/30318; G06F 17/30292; G06F 17/30339

(57) ABSTRACT

The present disclosure provides a method and system for implementing an analytic function based on MapReduce. The method includes: a table scan operator acquiring a data row from a file block, and sending the data row to a reduce sink operator; upon receipt of the data row, the reduce sink operator determining a reduce key, a partition key, and a sort key of the analytic function, and sending the data row to an analysis operator by means of a MapReduce framework; and upon receipt of the data row, the analysis operator analyzing the data row to obtain an analytic result, and forwarding the data row and the analytic result to a subsequent operator. The present disclosure can implement an analytic function in a distributed data warehouse of the MapReduce framework, thereby solving a problem that the analytic function cannot be used in the distributed data warehouse based on the MapReduce framework to perform data analytical processing.

### RELATED APPLICATIONS

This application is a continuation application of PCT Patent Application No. PCT/CN2013/084860, entitled “METHOD AND SYSTEM FOR IMPLEMENTING ANALYTIC FUNCTION BASED ON MAPREDUCE” filed on Oct. 9, 2013, which claims priority to Chinese Patent Application No. 201210580817.1, filed with the State Intellectual Property Office of the People's Republic of China on Dec. 27, 2012, and entitled “METHOD AND SYSTEM FOR IMPLEMENTING ANALYTIC FUNCTION BASED ON MAPREDUCE”, both of which are incorporated herein by reference in their entirety.

### FIELD OF THE TECHNOLOGY

The present disclosure relates to the field of data warehouses, and in particular, to a method and system for implementing an analytic function based on MapReduce.

### BACKGROUND OF THE DISCLOSURE

A data warehouse is a warehouse in which data is organized, stored, and managed according to a data structure. With popularization of computers, the data warehouse has been widely applied in work and life. Currently, with rapid development of Internet and information technologies, the data warehouse not only can store and manage data, but also has a strong data analysis capability. Common databases such as ORACLE and PostgreSQL all provide multiple analytic functions to analyze data according to user needs and provide analytic results to users. The analytic function is used to calculate an aggregate value based on a data group. Differing from the aggregate function, the analytic function returns multiple rows of data after processing the data group, while the aggregate function returns one row of data after processing the data group.

MapReduce is a programming model and is used to perform parallel computing on large-scale data sets. Currently, a distributed data warehouse (such as a Hive data warehouse) based on a MapReduce framework cannot use the analytic function to perform data processing, which brings much inconvenience in a process of using the database.

### SUMMARY

Embodiments of the present application provide a method and system for implementing an analytic function based on MapReduce, which can solve a problem that for a distributed database based on a MapReduce framework, the analytic function cannot be used to perform data processing.

In order to achieve the foregoing objective, the following technical solutions are used in the embodiments of the present application.

According to a first aspect, an embodiment of the present application provides a method for implementing an analytic function based on MapReduce, including: a table scan operator acquiring a data row from a file block, and sending the data row to a reduce sink operator; upon receipt of the data row, the reduce sink operator determining a reduce key, a partition key, and a sort key of the analytic function, and sending the data row to an analysis operator by means of a MapReduce framework, the analysis operator belonging to a Reduce end of the MapReduce framework; and upon receipt of the data row, the analysis operator analyzing the data row to obtain an analytic result, and forwarding the data row and the analytic result to a subsequent operator.

According to a second aspect, an embodiment of the present application further provides a computing system for implementing an analytic function based on MapReduce, the computing system including one or more processors and memory for storing a plurality of program modules to be executed by the one or more processors and the plurality of program modules further including: a table scan operator module, a reduce sink operator module, and an analysis operator module, the table scan operator module being configured to acquire a data row from a file block, and send the data row to the reduce sink operator module; the reduce sink operator module being configured to receive the data row, determine a reduce key, a partition key, and a sort key of the analytic function, and send the data row to the analysis operator module by means of a MapReduce framework, the analysis operator module belonging to a Reduce end of the MapReduce framework; and the analysis operator module being configured to receive the data row, analyze the data row to obtain an analytic result, and forward the data row and the analytic result to a subsequent operator module.

According to a third aspect, an embodiment of the present application further provides a non-transitory computer readable medium in conjunction with a computing system having one or more processors, the computer readable medium storing a plurality of program modules to be executed by the one or more processors for implementing an analytic function based on MapReduce, the plurality of program modules further comprising: a table scan operator module, a reduce sink operator module, an analysis operator module, and a subsequent operator module: a table scan operator module, a reduce sink operator module, and an analysis operator module, the table scan operator module being configured to acquire a data row from a file block, and send the data row to the reduce sink operator module; the reduce sink operator module being configured to receive the data row, determine a reduce key, a partition key, and a sort key of the analytic function, and send the data row to the analysis operator module by means of a MapReduce framework, the analysis operator module belonging to a Reduce end of the MapReduce framework; and the analysis operator module being configured to receive the data row, analyze the data row to obtain an analytic result, and forward the data row and the analytic result to a subsequent operator module.

The method and system for implementing an analytic function based on MapReduce provided in the embodiments of the present application can be applied in a distributed database based on a MapReduce framework (such as a Tencent distributed data warehouse and a Hive database) to implement data analysis and add a function of the distributed database based on the MapReduce framework, so that a user can perform data analysis in the distributed database based on the MapReduce framework.

### BRIEF DESCRIPTION OF THE DRAWINGS

To describe the technical solutions of the embodiments of the present application or the prior art more clearly, the following briefly introduces the accompanying drawings required for describing the embodiments or the prior art. Apparently, the accompanying drawings in the following description show only some embodiments of the present application, and a person of ordinary skill in the art may still derive other drawings from these accompanying drawings without creative efforts.

FIG. 1 is a schematic flowchart of a method for implementing an analytic function based on MapReduce according to Embodiment 1 of the present application;

FIG. 2 is a schematic flowchart of a method for implementing an analytic function based on MapReduce according to Embodiment 2 of the present application;

FIG. 3 is a schematic structural diagram of an analysis operator buffer according to Embodiment 2 of the present application;

FIG. 4 is a schematic structural diagram of an analyzer buffer according to Embodiment 2 of the present application;

FIG. 5A to FIG. 5D and FIG. 6A to FIG. 6D separately are schematic diagrams of a window mode according to Embodiment 2 of the present application;

FIG. 7 is a schematic structural diagram of a system for implementing an analytic function based on MapReduce according to Embodiment 3 of the present application; and

FIG. 8 is a schematic structural diagram of an analysis operator module 53 shown in FIG. 7.

### DESCRIPTION OF EMBODIMENTS

The following clearly and completely describes the technical solutions in the embodiments of the present application with reference to the accompanying drawings in the embodiments of the present application. Apparently, the described embodiments are merely some of the embodiments of the present application rather than all of the embodiments. All other embodiments obtained by a person of ordinary skill in the art based on the embodiments of the present application without creative efforts shall fall within the protection scope of the present disclosure.

### Embodiment 1

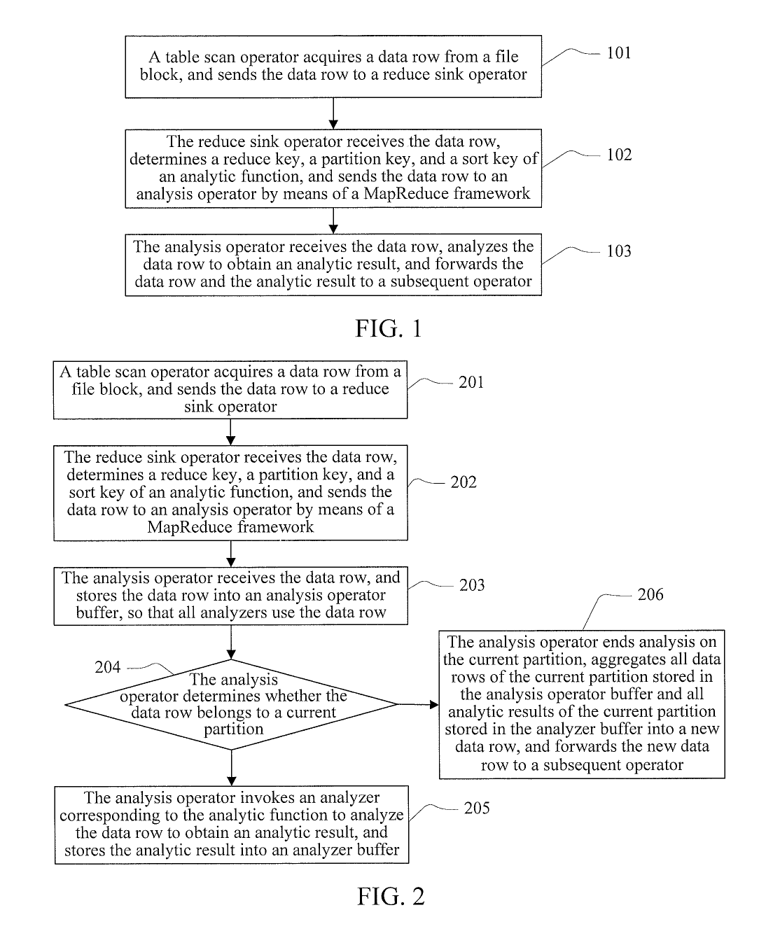

This embodiment of the present application provides a method for implementing an analytic function based on MapReduce. The method is applicable to data analysis in a distributed data warehouse based on a MapReduce framework. As shown in FIG. 1, the method includes the following steps.

Step 101: A table scan operator acquires a data row from a file block, and sends the data row to a reduce sink operator.

Step 102: The reduce sink operator receives the data row, determines a reduce key, a partition key, and a sort key of the analytic function, and sends the data row to an analysis operator by means of a MapReduce framework, where the analysis operator belongs to a Reduce end of the MapReduce framework.

Step 103: The analysis operator receives the data row, analyzes the data row to obtain an analytic result, and forwards the data row and the analytic result to a subsequent operator.

The subsequent operator may be determined according to operations needed by specific situations, for example, may be an aggregate operator, a filter operator, or a file operator, but is not limited thereto.

The method for implementing an analytic function based on MapReduce provided in this embodiment of the present application can be applied in an analytic function to perform data analysis in a distributed database based on a MapReduce framework (such as a Tencent distributed data warehouse and a Hive data warehouse), and add a function of the distributed database based on the MapReduce framework, so that the analytic function is used in the distributed database based on the MapReduce framework to perform data analysis.

### Embodiment 2

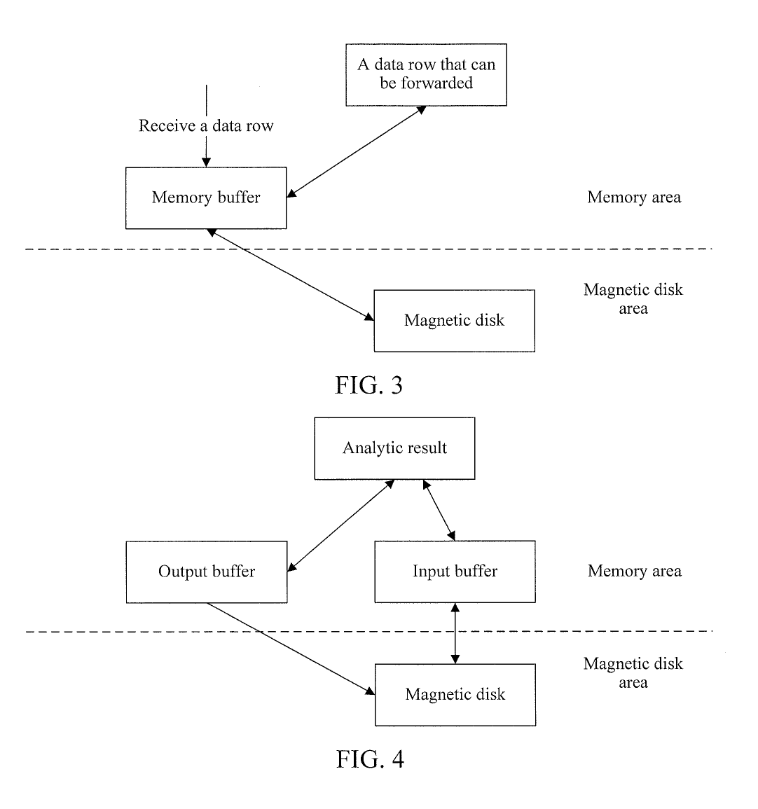

This embodiment of the present application provides a method for implementing an analytic function based on MapReduce. The method is applicable to data analysis in a distributed data warehouse based on a MapReduce framework. As shown in FIG. 2, the method includes the following steps.

Step 201: A table scan operator acquires a data row from a file block, and sends the data row to a reduce sink operator.

It should be noted that, in the method provided in this embodiment, multiple different analytic functions may be preset to analyze data. Exemplary analytic functions, for example, may include LAG, LEAD, RANK, DENSE_RANK, ROW_NUMBER, SUM, COUNT, AVG, MAX, MIN, or RATIO_TO_REPORT. Optionally, in the method provided in this embodiment, a new analytic function may be added according to user needs.

Step 202: The reduce sink operator receives the data row, determines a reduce key, a partition key, and a sort key of the analytic function, and sends the data row to an analysis operator by means of a MapReduce framework, where the analysis operator belongs to a Reduce end of the MapReduce framework.

For example, the reduce sink operator may determine the reduce key, the partition key, and the sort key of the analytic function by using the following method. The method may specifically include:

(1) when the analytic function comprises a partition by clause and/or an order by clause, using a column in the partition by clause and/or a column in the order by clause of the analytic function as the reduce key, when the analytic function does not comprise an order by clause but comprises a distinct key word, using a distinct column as the reduce key, when the analytic function does not comprise a partition by clause, an order by clause, or a distinct key word, designating any constant as the reduce key;

(2) when the analytic function comprises the partition by clause, using the column in the partition by clause of the analytic function as the partition key, or using a constant that is the same as the reduce key as the partition key when the analytic function does not comprise the partition by clause; and

(3) when the analytic function comprises the order by clause, use the column in the order by clause as the sort key.

Step 203: The analysis operator receives the data row, and stores the data row into an analysis operator buffer, so that all analyzers uses the data row.

In order to implement data sharing, an analysis operator buffer AnalysisBuffer may be provided in an analysis operator module formed by the analysis operator. The buffer has the following features: a. allowing data of a designated length to be stored in a memory; b. overflowing half content in an original memory buffer to a hard disk when a length exceeds a limit value; c. allowing a user to access an element in the buffer according to an index; and d. allowing a user to delete an element, which has been forwarded, in the buffer from the beginning.

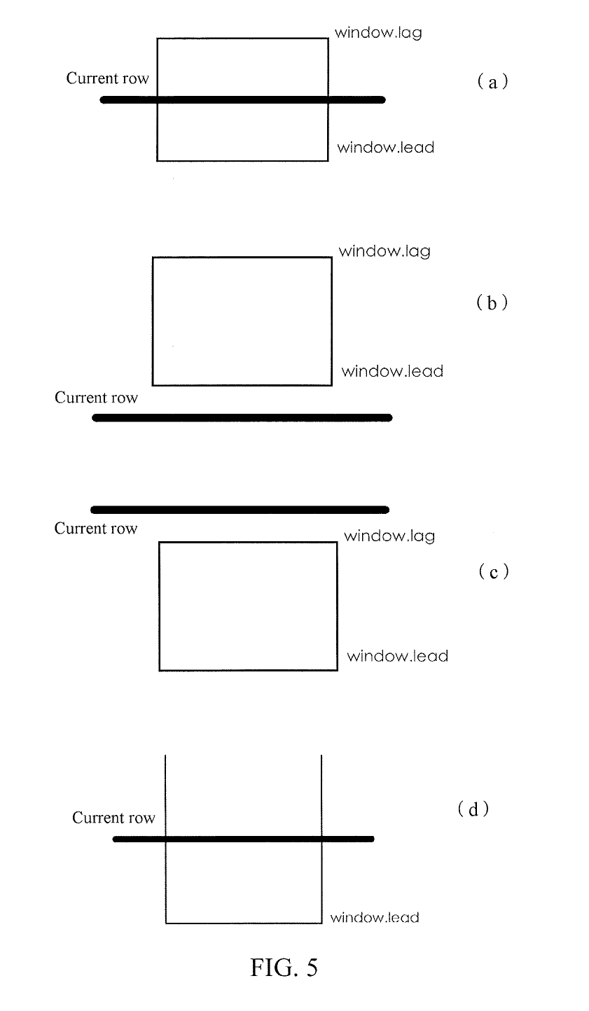

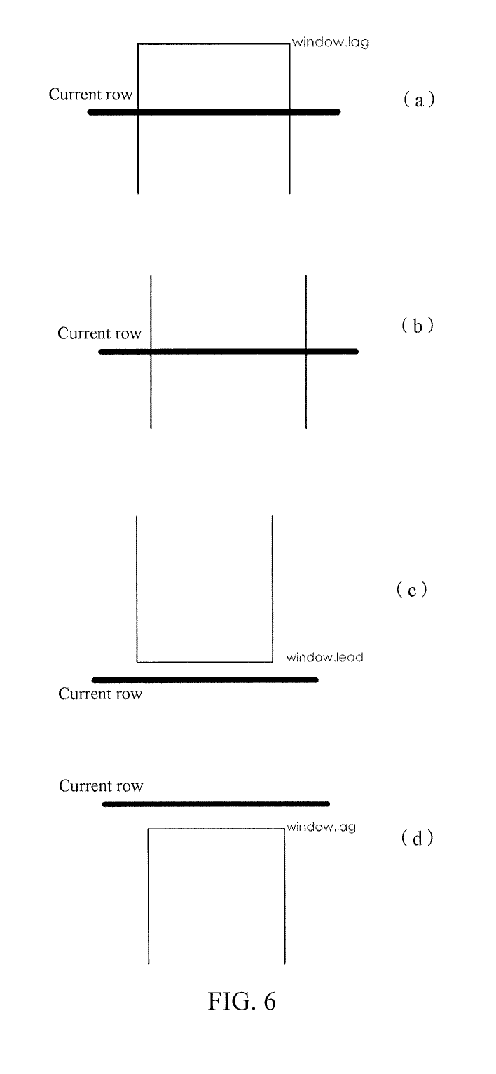

Specifically, as shown in FIG. 3, the analysis operator buffer may include the memory buffer and a magnetic disk buffer (which may be located in a magnetic disk shown in FIG. 4). In the analysis operator buffer, a received new data row may be preferentially put into the memory buffer; and if the memory buffer is full, an old data row in the memory buffer may be stored into the magnetic disk buffer, so as to release storage space of the memory buffer, and then the received new data row may be put into the memory buffer.

Step 204: The analysis operator parses out a partition by field and an order by field of the data row, determines whether the data row belongs to a current partition, the current partition is a partition to which a previous data row received by the analysis operator belongs; and if the data row belongs to the current partition, executes step 205; or if the data row does not belong to the current partition, executes step 206.

Step 205: The analysis operator invokes an analyzer corresponding to the analytic function to analyze the data row to obtain an analytic result, and stores the analytic result into an analyzer buffer.

It should be noted that each analytic function may correspond to one analyzer, and each analyzer may correspond to one analyzer buffer, which is used to store an analytic result and an intermediate result that are related to each data row, or a total aggregate result. As shown in FIG. 4, the analyzer buffer may include the memory buffer and the magnetic disk buffer (which may be located in the magnetic disk shown in FIG. 4), and the memory buffer may include an output buffer and an input buffer.

The analyzer buffer is used to buffer and update the analytic result. Specifically, when the analyzer buffer buffers the analytic result, the analytic result may be stored into the output buffer; and if the output buffer is full, content in the output buffer may be stored into the magnetic disk buffer, so as to release storage space of the output buffer. When the analyzer buffer updates the analytic result, if a to-be-updated row is stored in the output buffer, the analytic result may be directly updated according to the to-be-updated row and received new data in the output buffer; if the to-be-updated row is stored in the input buffer, the analytic result may be directly updated according to the to-be-updated row and received new data in the input buffer; and if the to-be-updated row is stored in the magnetic disk (that is, the magnetic disk buffer), content in the input buffer may be stored into the magnetic disk, and a buffer block in which the to-be-updated row in the magnetic disk is located is read into the input buffer, so as to update the analytic result according to the to-be-updated row and the received new data in the input buffer.

Step 206: The analysis operator ends analysis on the current partition, aggregates all data rows of the current partition stored in the analysis operator buffer and all analytic results of the current partition stored in the analyzer buffer into a new data row, and forwards the new data row to a subsequent operator.

It should be noted that if the analytic function does not need accumulation, after the analyzer corresponding to the analytic function is invoked to analyze the data row to obtain the analytic result, the data row and the analytic result may be directly aggregated, and forwarded to the subsequent operator, and the data row and the analytic result do not need to be buffered.

For ease of understanding, this embodiment briefly describes 11 common exemplary algorithms of the analytic function. Details are as follows.

Algorithm 1: a brief description of a LAG algorithm:

It is assumed that an invoked analytic function is lag(col, offset) over( . . . ).

There is only one row number counter p (an initial value is −1) in an analyzer buffer of LAG. When a new row is analyzed, p is increased by 1. If p>=offset, a column of a row to which p points is set to content at a col column of a p-offset row, and it indicates that content at the p-offset row and a preceding row may be forwarded; otherwise, a result of a current row is set to null, and all rows cannot be forwarded.

Algorithm 2: a brief description of a LEAD algorithm:

It is assumed that an invoked analytic function is lead(col, offset) over( . . . ).

There are two pointers in an analyzer buffer of LEAD. A pointer P1 points to a minimum row that has not been processed, and a pointer p2 points to a current row. When a new row is analyzed, the pointer p2 is increased by 1. In this case, if p2−p1>=offset, a result of a row to which the p1 points is set to content at a col column of a row to which the p2 points, and p1 increases by one (p1++), and rows having row numbers less than or equal to p1 may all be forwarded.

Algorithm 3: a brief description of a RANK algorithm:

There are a current sequence number rank, a value, value, corresponding to the current sequence number, and a row number, number, having the current sequence number in an analyzer buffer of RANK. When a new row is analyzed, if a value of the new row is equal to the value, a rank column of the row is set to the rank, and number++ in the analyzer buffer; otherwise, the rank column is set to rank+number, and at the same time, the rank in the analyzer buffer is set to the rank+number; the value is set to a designated value of the new row; and the number is set to 1. All rows that are currently processed can be forwarded.

Algorithm 4: a brief description of a DENSE_RANK algorithm:

There are a current sequence number rank, a value, value, corresponding to the current sequence number, and a row number, number, having the current sequence number in an analyzer buffer of DENSE_RANK. When a new row is analyzed, if a value of the new row is equal to the value, a rank column of the row is set to the rank, and number++ in the analyzer buffer; otherwise, the rank column is set to rank+1, and at the same time, the rank in the analyzer buffer is set to the rank+1; the value is set to a designated value of the new row; and the number is set to 1. All rows that are currently processed can be forwarded.

Algorithm 5: a brief description of a ROW_NUMBER algorithm:

There is only one rownumber value (an initial value is −1) in an analyzer buffer of ROW_NUMBER. When a new row is analyzed, a rownumber column of the new row is set to rownumber+1, and at the same time, the rownumber in the analyzer buffer is set to the rownumber+1. All rows that are currently processed can be forwarded.

Algorithm 6: a brief description of a SUM algorithm:

In an analyzer buffer of SUM, a variable, that is, a current sum, is stored. When a new row is analyzed, a value of the sum plus a value (which needs to be non-null) of a designated expression of the new row is stored into sum.

Forwarding cannot be performed before whole partition analysis is completed. After the partition analysis is completed, a value of the sum is used as a calculation result of each row.

Algorithm 7: a brief description of a COUNT algorithm:

There is only one count counter in an analyzer buffer of COUNT. Each time a new row is analyzed, if a value of a to-be-analyzed column is non-null, the counter is increased by 1.

Forwarding cannot be performed before whole partition analysis is completed. After the partition analysis is completed, a value of the count is used as a calculation result of each row.

Algorithm 8: a brief description of an AVG algorithm.

There are two counter values in an analyzer buffer of AVG. One is sum (an initial value is 0), and the other is count (an initial value is 0). When a new row is analyzed, if an expression is a non-null value, count++, and the sum is set to an expression value of a new row sum+.

Any row cannot be forwarded before whole partition analysis is completed. After the partition analysis is completed, if count!=0, a value of sum/count is used as a calculation result of each row; otherwise, null is used as an analytic result of each row.

Algorithm 9: a brief description of a MAX algorithm.

There is only one max value in an analyzer buffer of MAX. When a new row is analyzed, an expression (non-null) of the new row is a compared with max. If the expression is greater than max, max is updated. When partition analysis is completed, designated columns of all rows are set to max.

Forwarding cannot be performed before whole partition analysis is completed.

Algorithm 10: a brief description of a MIN algorithm.

There is only one min value in an analyzer buffer of MIN. When a new row is analyzed, an expression (non-null) of the new row is a compared with min. If the expression is less than min, min is updated. When partition analysis is completed, designated columns of all rows are set to min.

Forwarding cannot be performed before whole partition analysis is completed.

Algorithm 11: a brief description of a RATIO_TO_algorithm.

There is only one sum value in an analyzer buffer of a RATIO_TO_REPORT class. When a new row is analyzed, an expression (non-null) of the new row plus sum is set to a value of sum. When partition analysis is completed, designated columns of all rows respectively divided by sum are set to values of the columns. If sum is 0, the values of the columns are all set to null.

Forwarding cannot be performed before whole partition analysis is completed.

It should be noted that, in the analytic function, an aggregate value is calculated for each row of data based on a group of records (such as multiple data rows), to obtain an analytic result, where the based group of records is referred to as “window”. Each row of records has one window, which is used to designate the analytic function to execute a record set of aggregate computation. For a case in which there is a window clause, this embodiment provides the following 8 modes (that is, a window mode, specifically, a mode of setting a window location) to be referred to:

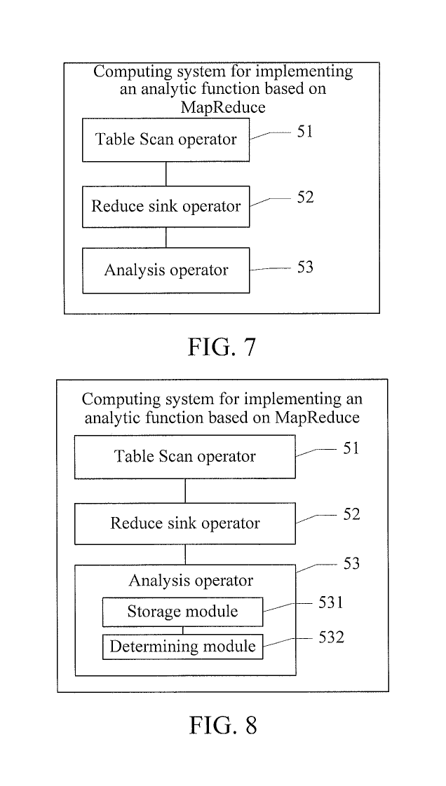

Mode 1 is shown in FIG. 5A:

Representative statements of the mode are:

Rows between window.lag preceding and window.lead following //located in a range from a window.lag row before a current row to a window.lead row after the current row; and

Range between window.lag preceding and window.lead following //a range from window.lag less (or greater) than a current value to window.lead greater (or less) than the current value.

Mode 2 is shown in FIG. 5B:

Representative statements of the mode are:

Rows between window.lag preceding and window.lead preceding //located in a range from a window.lag row before a current row to a window.lead row after the current row; and

Range between window.lag preceding and window.lead preceding //in a range from window.lag to window.lead that are less (or greater) than a current value.

Mode 3 is shown in FIG. 5C:

Representative statements of the mode are:

Rows between window.lag following and window.lead following //located in a range from a window.lag row before a current row to a window.lead arrow after the current row; and

Range between window.lag following and window.lead following //in a range from window.lag to window.lead that are greater (or less) than a current value.

Mode 4 is shown in FIG. 5D:

Representative statements of the mode are:

Rows between unbounded preceding and window.lead following //located in a range from the beginning to a window.lead row after a current row; and

Rows between unbounded preceding and window.lead following //in a range from the beginning to window.lead greater (or less) than a current value.

Mode 5 is shown in FIG. 6A:

Representative statements of the mode are:

Rows between window.lag preceding and unbounded following //located in a range from a window.lag row before a current row to the end; and

Range between window.lag preceding and unbounded following //in a range from window.lag less (or greater) than a current value to the end.

Mode 6 is shown in FIG. 6B:

Representative statements of the mode are:

Rows between unbounded preceding and unbounded following //from the beginning to the end; and

Rows between unbounded preceding and unbounded following //from the beginning to the end.

Mode 7 is shown in FIG. 6C:

Representative statements of the mode are:

Rows between unbounded preceding and window.lead preceding //in a range from the beginning to a row before a window.lead row; and

Range between unbounded preceding and window.lead preceding //in a range from the beginning to window.lead less (or greater) than a current value.

Mode 8 is shown in FIG. 6D:

Representative statements of the mode are:

Rows between window.lag following and unbounded following //in a range from a window.lag row after a current row to the end; and

Rows between window.lag following and unbounded following //in a range from window.lag greater (or less) than a current value to the end.

According to the foregoing eight modes, a processing algorithm of a corresponding analytic function may be easily implemented.

The method for implementing an analytic function based on MapReduce provided in this embodiment of the present application can be applied in a distributed database based on a MapReduce framework (such as a Tencent distributed data warehouse and a Hive data warehouse) to implement data analysis and add a function of the distributed database based on the MapReduce framework, so as to perform data analysis in the distributed database based on the MapReduce framework.

### Embodiment 3

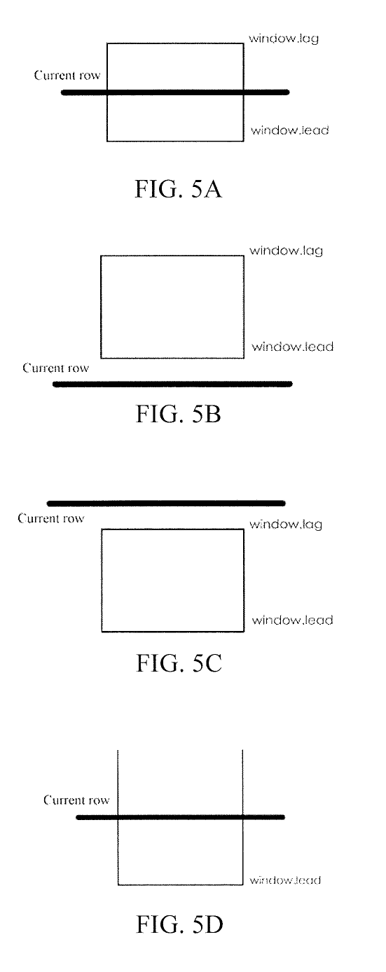

This embodiment of the present application provides a computing system for implementing an analytic function based on MapReduce, which can implement the foregoing method embodiments. In some embodiments, the computing system includes one or more processors; memory; and a plurality of program modules stored in the memory and to be executed by the one or more processors. As shown in FIG. 7, the plurality of program modules may further include a table scan operator 51, a reduce sink operator 52, and an analysis operator 53. The table scan operator 51 may form a table scan operator module or be included in a table scan operator module. In this embodiment, terms “table scan operator” and “table scan operator module” can be used interchangeably. The reduce sink operator 52 may form a reduce sink operator module or be included in a reduce sink operator module. In this embodiment, terms “reduce sink operator” and “reduce sink operator module” can be used interchangeably. The analysis operator 53 may form an analysis operator module or be included in an analysis operator module. In this embodiment, terms “analysis operator” and “analysis operator module” can be used interchangeably. The system may further include analysis operator buffers (not shown in the figure) that are the same as the analysis operator buffers described above. Therefore, the analysis operator buffers are not described in detail herein.

The table scan operator 51 is configured to acquire a data row from a file block, and send the data row to the reduce sink operator 52.

The reduce sink operator 52 is configured to receive the data row, determine a reduce key, a partition key, and a sort key of the analytic function, and send the data row to the analysis operator 53 by means of a MapReduce framework, where the analysis operator 53 belongs to a Reduce end of the MapReduce framework.

The analysis operator 53 receives the data row, analyzes the data row to obtain an analytic result, and forwards the data row and the analytic result to a subsequent operator.

Optionally, the reduce sink operator 52 may be specifically configured to: when the analytic function includes a partition by clause and/or an order by clause, use a column in the partition by clause and/or a column in the order by clause of the analytic function as the reduce key; or the reduce sink operator 52 may also be configured to use a distinct column as the reduce key when the analytic function does not include the order by clause but includes a distinct key word; or the reduce sink operator 52 may also be configured to designate any constant as the reduce key when the analytic function does not comprise a partition by clause, an order by clause, or a distinct key word.

The reduce sink operator 52 may be further configured to: when the analytic function includes the partition by clause, use the column in the partition by clause of the analytic function as the partition key; or the reduce sink operator 52 may be further configured to use a constant that is the same as the reduce key as the partition key when the analytic function does not comprise the partition by clause.

The reduce sink operator 52 may be further configured to: when the analytic function includes the order by clause, use the column in the order by clause as the sort key.

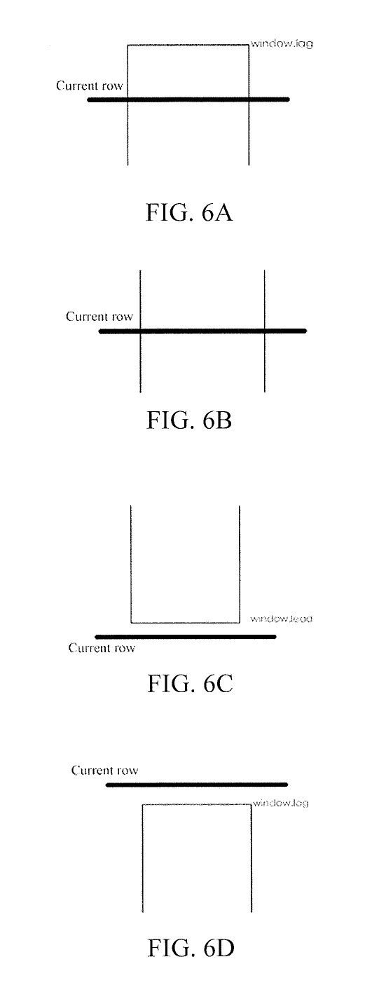

Further, as shown in FIG. 8, the analysis operator 53 may include:

a storage module 531, configured to receive the data row, and store the data row into an analysis operator buffer, so that all analyzers use the data row; and

a determining module 532, configured to parse out a partition by field and an order by field of the data row, and determine whether the data row belongs to a current partition, where the current partition is a partition to which a previous data row received by the analysis operator belongs, and if the data row belongs to the current partition the analysis operator 53 may invoke an analyzer corresponding to the analytic function to analyze the data row to obtain the analytic result, and store the analytic result into an analyzer buffer, or if the data row does not belong to the current partition, the analysis operator 53 may end analysis on the current partition, aggregate all data rows of the current partition stored in the analysis operator buffer and all analytic results of the current partition stored in the analyzer buffer into a new data row, and forward the new data row to the subsequent operator (that is, an operator module). The analyzer and the analyzer buffers are the same as those described above. The analyzer and the analyzer buffers may be located in the system according to Embodiment 3 of the present application, and may also be located outside the system and be operatively coupled to the system.

Optionally, if the analytic function does not need accumulation, after obtaining the analytic result, the analysis operator 53 may directly aggregate the data row and the analytic result, and forward the data row and the analytic result to the subsequent operator (that is, the operator module), and the data row and the analytic result do not need to be buffered.

The system for implementing an analytic function based on MapReduce provided in this embodiment of the present application can be applied in a distributed database based on a MapReduce framework (such as a Tencent distributed data warehouse and a Hive database) to implement data analysis and add a function of the distributed database based on the MapReduce framework, so that the analytic function is used in the distributed database based on the MapReduce framework to perform data analysis.

Based on the foregoing descriptions of the embodiments, a person skilled in the art may clearly understand that the present disclosure may be implemented by software plus necessary universal hardware, and certainly, the present disclosure may also be implemented by hardware. However, in many cases, the former is a preferred implementation manner. Based on such an understanding, the technical solutions of the present application essentially, or the part contributing to the prior art may be implemented in a form of a software product. The computer software product is stored in a readable storage medium such as a floppy disk of a computer, a magnetic disk, an optical disc, or the like, and includes several instructions for instructing a computer device (which may be a personal computer, a server, a network device, or the like) to perform the methods described in the embodiments of the present application.

The foregoing descriptions are merely specific embodiments of the present application, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the appended claims.

What is claimed is:

1. A method for implementing an analytic function based on MapReduce, comprising:
at a computing system having one or more processors and memory for storing a plurality of program modules to be executed by the one or more processors:
a table scan operator acquiring a data row from a file block and sending the data row to a reduce sink operator;
upon receipt of the data row, the reduce sink operator determining a reduce key, a partition key, and a sort key of an analytic function, and sending the data row to an analysis operator by means of a MapReduce framework, the analysis operator belonging to a Reduce end of the MapReduce framework; and
upon receipt of the data row, the analysis operator analyzing the data row to obtain an analytic result, and forwarding the data row and the analytic result to a subsequent operator.

2. The method according to claim 1, wherein the step of the reduce sink operator determining a reduce key, a partition key, and a sort key of the analytic function further comprises:
when the analytic function comprises a partition by clause and/or an order by clause, using a column in the partition by clause and/or a column in the order by clause of the analytic function as the reduce key, when the analytic function does not comprise an order by clause but comprises a distinct key word, using a distinct column as the reduce key, when the analytic function does not comprise a partition by clause, an order by clause, or a distinct key word, designating any constant as the reduce key;
when the analytic function comprises the partition by clause, using the column in the partition by clause of the analytic function as the partition key, or using a constant that is the same as the reduce key as the partition key when the analytic function does not comprise the partition by clause; and
when the analytic function comprises the order by clause, use the column in the order by clause as the sort key.

3. The method according to claim 1, wherein the step of the analysis operator analyzing the data row to obtain an analytic result, and forwarding the data row and the analytic result to a subsequent operator further comprises:
upon receipt of the data row, the analysis operator storing the data row into an analysis operator buffer, so that all analyzers use the data row;
the analysis operator parsing out a partition by field and an order by field of the data row, determining whether the data row belongs to a current partition, wherein the current partition is a partition to which a previous data row received by the analysis operator belongs;
when the data row belongs to the current partition, the analysis operator invoking an analyzer corresponding to the analytic function to analyze the data row to obtain the analytic result, and storing the analytic result into an analyzer buffer; and
when the data row does not belong to the current partition, the analysis operator terminating the analysis on the current partition, aggregating data rows of the current partition stored in the analysis operator buffer and analytic results of the current partition stored in the analyzer buffer into a new data row, and forwarding the new data row to the subsequent operator.

4. The method according to claim 3, wherein, when the analytic function does not need to perform the aggregation, after invoking an analyzer corresponding to the analytic function to analyze the data row to obtain the analytic result, the data row and the analytic result are directly aggregated and forwarded to the subsequent operator without buffering the data row and the analytic result.

5. The method according to claim 3, wherein the analysis operator buffer further comprises a memory buffer and a magnetic disk buffer, the analysis operator buffer is configured to put the received new data row into the memory buffer first; and when the memory buffer is full, the analysis operator buffer is configured to move an existing data row in the memory buffer into the magnetic disk buffer, so as to release storage space in the memory buffer for new data rows.

6. The method according to claim 3, wherein the analyzer buffer further comprises a memory buffer and a magnetic disk buffer, the memory buffer further comprises an output buffer and an input buffer, and the analyzer buffer is used to buffer and update the analytic result;
when the analyzer buffer buffers the analytic result, the analytic result is stored into the output buffer, and when the output buffer is full, content in the output buffer is moved into the magnetic disk buffer, so as to release storage space in the output buffer for new analytical results; and
when the analyzer buffer updates the analytic result,
the analytic result is directly updated according to a to-be-updated row and received new data in the output buffer when the to-be-updated row is stored in the output buffer,
the analytic result is directly updated according to a to-be-updated row and received new data in the input buffer when the to-be-updated row is stored in the input buffer, and
content in the input buffer is moved into the magnetic disk buffer, and a buffer block including a to-be-updated row in the magnetic disk buffer is read into the input buffer, so as to update the analytic result according to the to-be-updated row and the received new data in the input buffer when the to-be-updated row is stored in the magnetic disk buffer.

7. A computing system for implementing an analytic function based on MapReduce, comprising:
one or more processors;
memory; and
a plurality of program modules stored in the memory and to be executed by the one or more processors, the plurality of program modules further comprising a table scan operator module, a reduce sink operator module, an analysis operator module, and a subsequent operator module, wherein:
the table scan operator module is configured to acquire a data row from a file block, and send the data row to the reduce sink operator module;
the reduce sink operator module is configured to receive the data row, determine a reduce key, a partition key, and a sort key of the analytic function, and send the data row to the analysis operator module by means of a MapReduce framework, the analysis operator module belonging to a Reduce end of the MapReduce framework; and
the analysis operator module is configured to receive the data row, analyze the data row to obtain an analytic result, and forward the data row and the analytic result to the subsequent operator module.

8. The computing system according to claim 7, wherein the reduce sink operator module is configured to:
when the analytic function comprises a partition by clause and/or an order by clause, use a column in the partition by clause and/or a column in the order by clause of the analytic function as the reduce key, when the analytic function does not comprise an order by clause but comprises a distinct key word, use a distinct column as the reduce key, when the analytic function does not comprise a partition by clause, an order by clause, or a distinct key word, designate any constant as the reduce key;
when the analytic function comprises the partition by clause, use the column in the partition by clause of the analytic function as the partition key, or use a constant that is the same as the reduce key as the partition key when the analytic function does not comprise the partition by clause; and
when the analytic function comprises the order by clause, use the column in the order by clause as the sort key.

9. The computing system according to claim 7, wherein the analysis operator module further comprises:
a storage module, configured to receive the data row, and store the data row into an analysis operator buffer, so that all analyzers use the data row; and
a determining module, configured to parse out a partition by field and an order by field of the data row, determine whether the data row belongs to a current partition, wherein the current partition is a partition to which a previous data row received by the analysis operator belongs, wherein:
when the data row belongs to the current partition, the analysis operator module is configured to invoke an analyzer corresponding to the analytic function to analyze the data row to obtain the analytic result, and store the analytic result into an analyzer buffer; and
when the data row does not belong to the current partition, the analysis operator module is configured to terminate the analysis on the current partition, aggregate data rows of the current partition stored in the analysis operator buffer and analytic results of the current partition stored in the analyzer buffer into a new data row, and forward the new data row to the subsequent operator module.

10. The computing system according to claim 9, wherein, when the analytic function does not need to perform the aggregation, after invoking an analyzer corresponding to the analytic function to analyze the data row to obtain the analytic result, the data row and the analytic result are directly aggregated and forwarded to the subsequent operator module without buffering the data row and the analytic result.

11. The computing system according to claim 9, wherein the analysis operator buffer further comprises a memory buffer and a magnetic disk buffer, the analysis operator buffer is configured to put the received new data row into the memory buffer first; and when the memory buffer is full, the analysis operator buffer is configured to move an existing data row in the memory buffer into the magnetic disk buffer, so as to release storage space in the memory buffer for new data rows.

12. The computing system according to claim 9, wherein the analyzer buffer further comprises a memory buffer and a magnetic disk buffer, the memory buffer further comprises an output buffer and an input buffer, and the analyzer buffer is used to buffer and update the analytic result;
when the analyzer buffer buffers the analytic result, the analytic result is stored into the output buffer, and when the output buffer is full, content in the output buffer is moved into the magnetic disk buffer, so as to release storage space in the output buffer for new analytical results; and
when the analyzer buffer updates the analytic result,
the analytic result is directly updated according to a to-be-updated row and received new data in the output buffer when the to-be-updated row is stored in the output buffer,
the analytic result is directly updated according to a to-be-updated row and received new data in the input buffer when the to-be-updated row is stored in the input buffer, and
content in the input buffer is moved into the magnetic disk buffer, and a buffer block including a to-be-updated row in the magnetic disk buffer is read into the input buffer, so as to update the analytic result according to the to-be-updated row and the received new data in the input buffer when the to-be-updated row is stored in the magnetic disk buffer.

13. A non-transitory computer readable medium in conjunction with a computing system having one or more processors, the computer readable medium storing a plurality of program modules to be executed by the one or more processors for implementing an analytic function based on MapReduce, the plurality of program modules further comprising a table scan operator module, a reduce sink operator module, an analysis operator module, and a subsequent operator module, wherein:
the table scan operator module is configured to acquire a data row from a file block, and send the data row to the reduce sink operator module;
the reduce sink operator module is configured to receive the data row, determine a reduce key, a partition key, and a sort key of the analytic function, and send the data row to the analysis operator module by means of a MapReduce framework, the analysis operator module belonging to a Reduce end of the MapReduce framework; and
the analysis operator module is configured to receive the data row, analyze the data row to obtain an analytic result, and forward the data row and the analytic result to the subsequent operator module.

14. The non-transitory computer readable medium according to claim 13, wherein the reduce sink operator module is configured to:
when the analytic function comprises a partition by clause and/or an order by clause, use a column in the partition by clause and/or a column in the order by clause of the analytic function as the reduce key, when the analytic function does not comprise an order by clause but comprises a distinct key word, use a distinct column as the reduce key, when the analytic function does not comprise a partition by clause, an order by clause, or a distinct key word, designate any constant as the reduce key;
when the analytic function comprises the partition by clause, use the column in the partition by clause of the analytic function as the partition key, or use a constant that is the same as the reduce key as the partition key when the analytic function does not comprise the partition by clause; and
when the analytic function comprises the order by clause, use the column in the order by clause as the sort key.

15. The non-transitory computer readable medium according to claim 13, wherein the analysis operator module further comprises:
a storage module, configured to receive the data row, and store the data row into an analysis operator buffer, so that all analyzers use the data row; and
a determining module, configured to parse out a partition by field and an order by field of the data row, determine whether the data row belongs to a current partition, wherein the current partition is a partition to which a previous data row received by the analysis operator belongs, wherein:
when the data row belongs to the current partition, the analysis operator module is configured to invoke an analyzer corresponding to the analytic function to analyze the data row to obtain the analytic result, and store the analytic result into an analyzer buffer; and
when the data row does not belong to the current partition, the analysis operator module is configured to terminate the analysis on the current partition, aggregate data rows of the current partition stored in the analysis operator buffer and analytic results of the current partition stored in the analyzer buffer into a new data row, and forward the new data row to the subsequent operator module.

16. The non-transitory computer readable medium according to claim 15, wherein, when the analytic function does not need to perform the aggregation, after invoking an analyzer corresponding to the analytic function to analyze the data row to obtain the analytic result, the data row and the analytic result are directly aggregated and forwarded to the subsequent operator module without buffering the data row and the analytic result.

17. The non-transitory computer readable medium according to claim 15, wherein the analysis operator buffer further comprises a memory buffer and a magnetic disk buffer, the analysis operator buffer is configured to put the received new data row into the memory buffer first; and when the memory buffer is full, the analysis operator buffer is configured to move an existing data row in the memory buffer into the magnetic disk buffer, so as to release storage space in the memory buffer for new data rows.

18. The non-transitory computer readable medium according to claim 15, wherein the analyzer buffer further comprises a memory buffer and a magnetic disk buffer, the memory buffer further comprises an output buffer and an input buffer, and the analyzer buffer is used to buffer and update the analytic result;
when the analyzer buffer buffers the analytic result, the analytic result is stored into the output buffer, and when the output buffer is full, content in the output buffer is moved into the magnetic disk buffer, so as to release storage space in the output buffer for new analytical results; and
when the analyzer buffer updates the analytic result,
the analytic result is directly updated according to a to-be-updated row and received new data in the output buffer when the to-be-updated row is stored in the output buffer,
the analytic result is directly updated according to a to-be-updated row and received new data in the input buffer when the to-be-updated row is stored in the input buffer, and
content in the input buffer is moved into the magnetic disk buffer, and a buffer block including a to-be-updated row in the magnetic disk buffer is read into the input buffer, so as to update the analytic result according to the to-be-updated row and the received new data in the input buffer when the to-be-updated row is stored in the magnetic disk buffer.
